(19) United States
(12) Patent Application Publication
(10) Pub. No.: US 2004/0261725 A1
(43) Pub. Date: Dec. 30, 2004

(54) Storage containers and method of storing products used by animals

(75) Inventor: Ward Myers, Wayzata, MN (US)

Correspondence Address: Z. Peter Sawicki, Westman, Champlin & Kelly, Suite 1600, 900 Second Avenue South, Minneapolis, MN, 55402-3319, US

(73) Assignee: Hyper Products, Inc., Wayzata, MN

(21) Appl. No.: 10/773,018

(22) Filed: Feb. 5, 2004

Related U.S. Application Data
(60) Provisional application No. 60/479,677, filed on Jun. 19, 2003.

(51) Int. Cl. A01K 1/10

(52) U.S. Cl. 119/51.01

(57) ABSTRACT

A method of storing pet food, birdseed, cat litter or animal bedding including providing a container wherein the container includes a bottom wall and a sidewall and wherein the sidewall is flexible and is initially in a collapsed state, and a top wall that is movable between an opened and closed position to provide access to the interior of the container. For use, the sidewall is distended to a substantially taut position. The sidewall is supported by a spring disposed therein. Storing pet food, cat litter, birdseed or animal bedding within the distended container.

The present application is based on and claims the benefit of U.S. provisional patent application Ser. No. 60/479,677, filed Jun. 19, 2003, the content of which is hereby incorporated by reference in its entirety.

### BACKGROUND OF THE INVENTION

The present invention relates to storage containers for storing animal related products such as pet food, birdseed, cat litter and animal bedding. In particular, the present invention relates to a collapsible container that collapses to a compact configuration for storage when not in use.

Dog food, birdseed, cat litter and animal bedding are often times stored in a garage. The packaging in which these products are sold is not conducive for storage. Typically, such products come in flexible packaging such as bags. The bags are susceptible to moisture which over a period of time may render the product unusable. Furthermore, pet food and birdseed attract rodents such as mice, chipmunks and squirrels and insects. Bags are easily breached by rodents and insects which may spoil the pet food or birdseed beyond use.

An alternative to the packaging of such products are rigid plastic containers. However, the problem with plastic containers is when they are not in use, such containers occupy valuable storage space.

### SUMMARY OF THE INVENTION

The present invention includes a method of storing pet food, birdseed, cat litter or animal bedding by providing a container wherein the container includes a bottom wall and a sidewall and wherein the sidewall is flexible and is initially in a collapsed state, and a top wall that is movable between an open and a closed position providing access to an interior of the container; distending the sidewall to a substantially taut position, the sidewall being supported by a spring disposed therein; and storing pet food, cat litter, birdseed or animal bedding within the distended container.

### BRIEF DESCRIPTION OF THE DRAWING

FIG. 1 is a perspective view of a collapsed container used in the method of the present invention.

FIG. 2 is a perspective view of a distended container used in the method of the present invention.

FIG. 3 is an exploded view of the distended container used in the present invention

### DETAILED DESCRIPTION

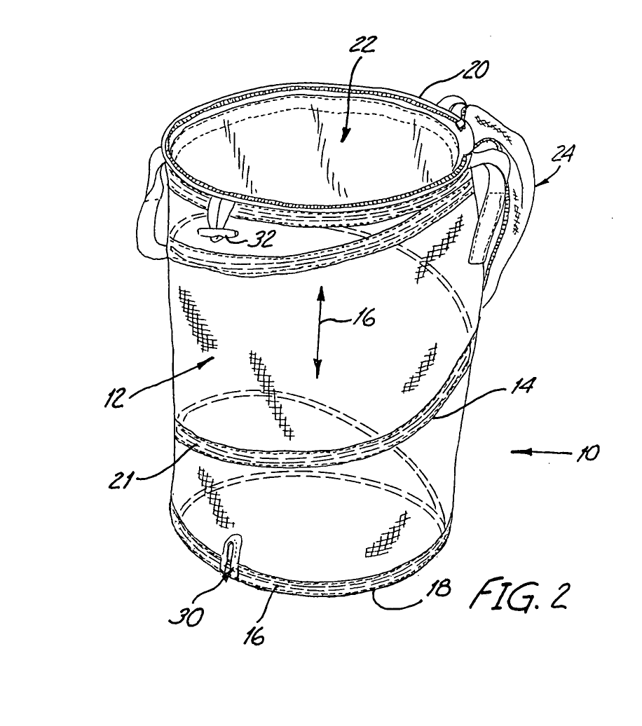

The storage container 10 used in the method of the present invention preferably has a vertical wall of double wall construction of fabric 12 as illustrated in FIG. 2. A coil spring 14 as indicated by broken lines provides structural integrity to the fabric such that the vertical walls (which are cylindrical in configuration) are held in a taut distended position. The taut distended position is accomplished by the coil springs' helix configuration and the springs desire to expand when not restrained. Since the coil spring exerts forces in the direction of arrows 16, the spring places and holds the vertical fabric walls 12 of the storage container 10 in the taut position.

A lower end coil of the coil spring 14 provides a support for the bottom wall 18 of the container 10. Similarly, an upper coil 20 forms an opening 22 by providing a rigid edge to the fabric at the opening 22.

A fabric cover 24 has one edge 26 permanently sewn to the vertical wall 12, and has a zipper 28 that is operable to secure the cover 24 to the opening 20 of the container 10.

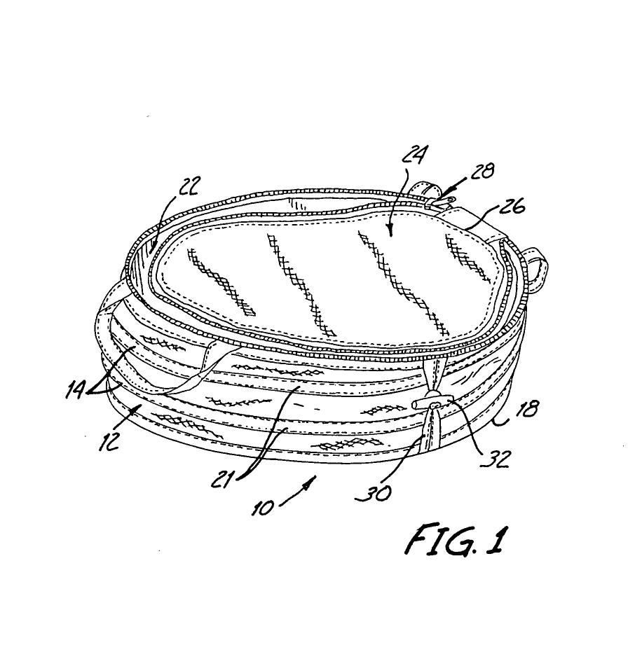

Although the storage container 10 is described to include a double wall construction with the coil spring positioned between the walls, it is also possible for the coil spring to be secured to a single wall by a band of material 21 encompassing the coil spring following the helical configuration of the spring as specifically illustrated in FIG. 2 or by any other mechanism. The coil spring being disposed between the band and the fabric wall is secured in position with respect to the fabric wall 12. Therefore, when the coil spring is compressed, the fabric wall follows the compression of the spring 14 and collapses as illustrated in FIG. 1. When the coil spring is released, the fabric wall 12 expands with the spring 14 to the taut position as illustrated in FIG. 2.

In a double wall construction, the coil spring is held in position with respect to the fabric wall preferably by a sewn line of thread disposed on both sides of the coil spring 14 as it extends through the wall in a helical configuration. Similarly, the bottom and top ends of the coils are also secured to the fabric by sewn thread lines.

To secure the storage container 10 in a collapsed state, the container is manually compressed against the floor. Two loops 30 of fabric are disposed 180° from each other on one end of the container. At another end of the container, pegs 32 are attached also at respective positions 180° from each other and aligned with the loops 30 of fabric. When the storage container is compressed as illustrated in FIG. 1, the pegs 32 engage the loops 30 to secure the container in a collapsed position. Although a specific mechanism for securing the container in a collapsed position has been described, it should be understood that any type of a securing system that retains the container in a collapsed position is within the scope of the present invention.

The fabric walls of the storage container 10 are preferably made of a waterproof plastic. The fabric must be flexible enough so that it collapses and conforms to the helical configuration of the coil spring. However, the plastic must also be sturdy enough to withstand wear and tear associated with containers that are used for storing feed, seed, bedding and cat litter. The need for having the storage container being waterproof is to protect and maintain the integrity of items such as pet food. If the pet food is stored in a garage, humidity and other factors such as rodents and insects may affect the integrity of the feed, seed or cat litter.

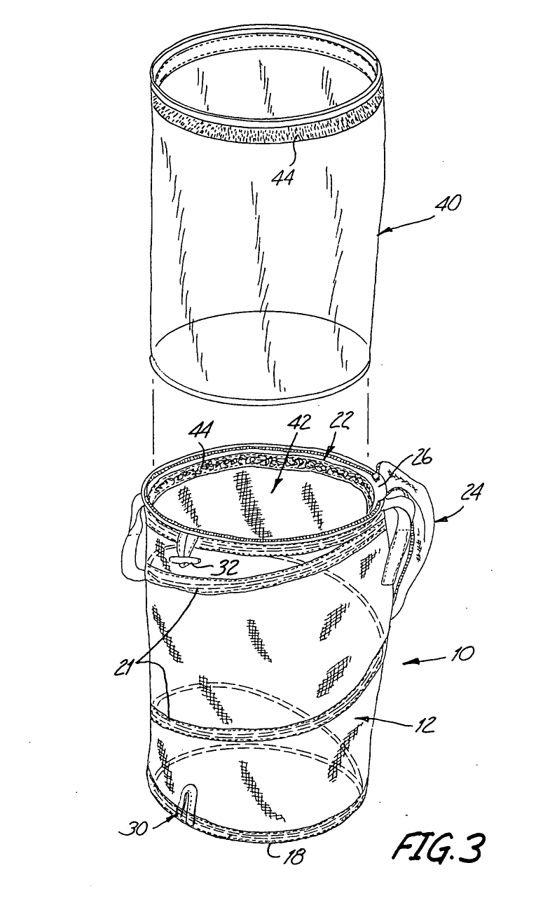

To further provide a moisture barrier, the present invention includes a liner 40 that is illustrated in FIG. 3 being pulled out from within the interior of the storage container 10. The liner 40 not only provides an additional moisture barrier, but since it is not secured to the wall 12 of the storage container 10, the liner 40 can be pulled out and cleaned. The liner 40 is secured preferably to the container 10 by a hook and loop fastener system 44 such as Velcro® proximate the opening 22 so that the liner 40 may be detached for cleaning.

The storage container of the present invention may be used for a wide variety of feed items. As previously mentioned, it is useful for storing dog food or cat food. Birdseed may also be stored within the container 10. Cat litter needs to be protected from humidity to be effective and storage in the container of the present invention is ideal.

Other uses for the container of the present invention include use with animals that are stalled or penned separately such as horses boarded and owned by different owners in a horse barn or various species of animals in a zoo. Often times such animals have a feed composition that is formulated for a particular species, or a particular life cycle (pregnancy, weaning, nursing or the like) or feed that is specifically formulated for the individual animal such as in a horse barn. Such individually formulated feed needs to be stored in a segregated manner. However, the number of storage containers required may be many which results in a storage problem for the containers when not in use. The storage container 10 provides a solution to such a problem. When not in use the storage container is collapsed to a fraction of its original volume thereby alleviating the problem of storing many storage containers.

Although the present invention has been described with reference to preferred embodiments, workers skilled in the art will recognize that changes may be made in form and detail without departing from the spirit and scope of the invention.

What is claimed is:

1. A method of storing an animal food, cat litter, or animal bedding the method comprising:
providing a container wherein the container includes a top wall, bottom wall and sidewall and wherein the sidewall is flexible and is in a collapsed state;
distending the sidewall to a substantially taut position, the sidewall being supported by a spring disposed therein; and
storing animal feed within the distended container.

2. The method of claim 1 and further comprising:
placing the container after being emptied of animal feed back into a collapsed state.

3. The method of claim 2 wherein the container is collapsed by pressing down on the sidewall against the spring force.

4. The method of claim 2 wherein the container is retained in the collapsed state by a fastening mechanism attached to an edge of the bottom wall and to a top edge of the sidewall.

5. A method of storing animal feed wherein different feed formulations are fed to a plurality of animals, the method comprising:
providing a plurality of containers wherein the containers each include a top wall, bottom wall and sidewall wherein the sidewall is flexible and in a collapsed state;
distending the sidewall to a substantially taut position wherein the sidewall is supported by a spring disposed therein;
placing animal feed within the distended container.

6. The method of claim 5 and further comprising:
feeding the animals the animal feed; and
placing the containers which are emptied of feed back into the collapsed position.

7. The method of claim 6 wherein the containers are placed in the collapsed position by pressing down on the sidewall against the spring force and engaging a mechanism to hold the containers in a collapsed state for storage until the containers are needed to feed the animals once again.

8. The method of claim 6 and storing the containers wherein the containers are retained in the collapsed state by a fastening mechanism attached to an edge of the bottom wall and to a top edge of the sidewall
